(19) United States
(12) Patent Application Publication
(10) Pub. No.: US 2014/0032441 A1
(43) Pub. Date: Jan. 30, 2014

(54) Field Extensibility Self Healing After Incompatible Changes

(71) Applicants: Uwe Schlarb, Oestringen (DE); Daniel Wachs, Frankenthal (DE); Daniel Figus, Wallduern (DE); Stefan Beauerle, Rauenberg-Rotenberg (DE); Daniel Niehoff, Sandhausen (DE)

(72) Inventors: Uwe Schlarb, Oestringen (DE); Daniel Wachs, Frankenthal (DE); Daniel Figus, Wallduern (DE); Stefan Beauerle, Rauenberg-Rotenberg (DE); Daniel Niehoff, Sandhausen (DE)

(73) Assignee: SAP AG, Walldorf (DE)

(21) Appl. No.: 13/559,173

(22) Filed: Jul. 26, 2012

(51) Int. Cl. G06Q 10/06

(52) U.S. Cl. 705/348

(57) ABSTRACT

A system, a method, and a computer program product for adapting field extensibilities of business objects to changes in business processes are disclosed. An upgrade information for a business object model is received. Data and metadata associated with at least one field extension of at least one business object in the business object model to be migrated to an upgraded business object model are determined based on the received upgrade information. The determined data and metadata are migrated to the upgraded business object model.

### TECHNICAL FIELD

This disclosure relates generally to data processing and, in particular, to adaptability of field extensibilities of business objects to changes in business processes.

### BACKGROUND

Businesses implement a plurality of business processes in their daily operations, where business processes can be managed by various enterprise information systems. Typical business processes can relate to accounting, collaboration, customer relationship management (“CRM”), management information systems (“MIS”), enterprise resource planning (“ERP”), invoicing, human resource management (“HRM”), content management (“CM”), service desk management, etc. Business processes can involve a plurality of business objects (e.g., a sales order, an invoice, an account, etc.) relating to the above activities of the businesses. Business objects can be structured objects that can include a root node and child nodes (e.g., a sales order having a company name as a root node and other information associated with the order as child nodes). Business objects can be connected to one another via data flows, where metadata can be associated with such business objects and data flows as well as the business processes that a business objects can be part of and can be used to identify, retrieve, and manipulate business processes, business objects, and/or data flows. Businesses can rely on products/services provided by its partners to offer business services/products to its customers.

To ensure flexibility and availability of various functionalities associated with business processes to its customers and/or partners, businesses can provide the customers and/or partners with abilities to adapt or extend its business process software architecture to various individual requirements. This can enable customers and/or partners of the business, to obtain different features, enhance existing features, etc. of the offered business processes. Businesses can offer these abilities through field extensibility that can enable customers and/or partners to add various extension fields to already existing business processes, business objects and/or data flows that are may be part of the core products/services being offered. However, when the core products/services are redesigned and/or changed, some and/or all of the field extensibilities can be lost or rendered inoperable thereby causing partner and/or customer add-ons to be disabled and/or unusable.

### SUMMARY

In some implementations, a computer implemented method for adapting field extensibilities of business objects to changes in business processes is disclosed. The method can include receiving an upgrade information for a business object model, determining, based on the receiving, data and metadata associated with at least one field extension of at least one business object in the business object model to be migrated to an upgraded business object model, and migrating the determined data and metadata to the upgraded business object model. At least one of the receiving, the determining, and the migrating can be performed on at least one processor.

In some implementations, the current subject matter can include one or more of the following optional features. The method can include performing a consistency check of the determined data associated with the at least one field extension of the at least one business object, determining whether the data passed the consistency check, and storing the determined data in the upgraded business object model.

In some implementations, the method can include performing a consistency check of the determined metadata associated with the at least one field extension of the at least one business object, determining whether the metadata passed the consistency check, and storing the determined metadata in the upgraded business object model.

The data and metadata can be stored in at least one extensibility table. At least one extensibility table can be migrated to the upgraded business object model. The method can also include performing a consistency check of the at least one extensibility table.

In some implementations, the method can include determining existence of at least one custom field extension in the business object model, migrating the at least one custom field extension from to the upgraded business object model, and performing a consistency check of the migrated at least one custom field extension.

At least one field extension can represent at least one business process associated with the business object model.

In some implementations, the method can include performing a consistency check of the at least one field extension of the at least one business object during at least one: a deployment of the at least one business object in the at least one of the business object model and the upgraded business object model, and a regeneration of the at least one business object in the at least one of the business object model and the upgraded business object model.

Articles are also described that comprise a tangibly embodied machine-readable medium embodying instructions that, when performed, cause one or more machines (e.g., computers, etc.) to result in operations described herein. Similarly, computer systems are also described that can include a processor and a memory coupled to the processor. The memory can include one or more programs that cause the processor to perform one or more of the operations described herein.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an exemplary system, according to some implementations of the current subject matter;

FIG. 2 illustrates an exemplary business organization system, according to some implementations of the current subject matter;

FIG. 3 is a diagram illustrating aspects of an example of a software architecture, according to some implementations of the current subject matter;

FIG. 4 is a diagram illustrating aspects of another example of a software architecture, according to some implementations of the current subject matter; and

FIG. 5 is a diagram illustrating aspects of a repository, according to some implementations of the current subject matter;

FIG. 6 illustrates an exemplary system, according to some implementations of the current subject matter; and

FIG. 7 illustrates an exemplary method, according to some implementations of the current subject matter.

### DETAILED DESCRIPTION

To address these and potentially other deficiencies of currently available solutions, one or more implementations of the current subject matter provide methods, systems, articles or manufacture, and the like that can, among other possible advantages, provide systems and methods for providing systems, methods, and computer program products for providing an ability to adapt field extensibilities to changes in core business processes.

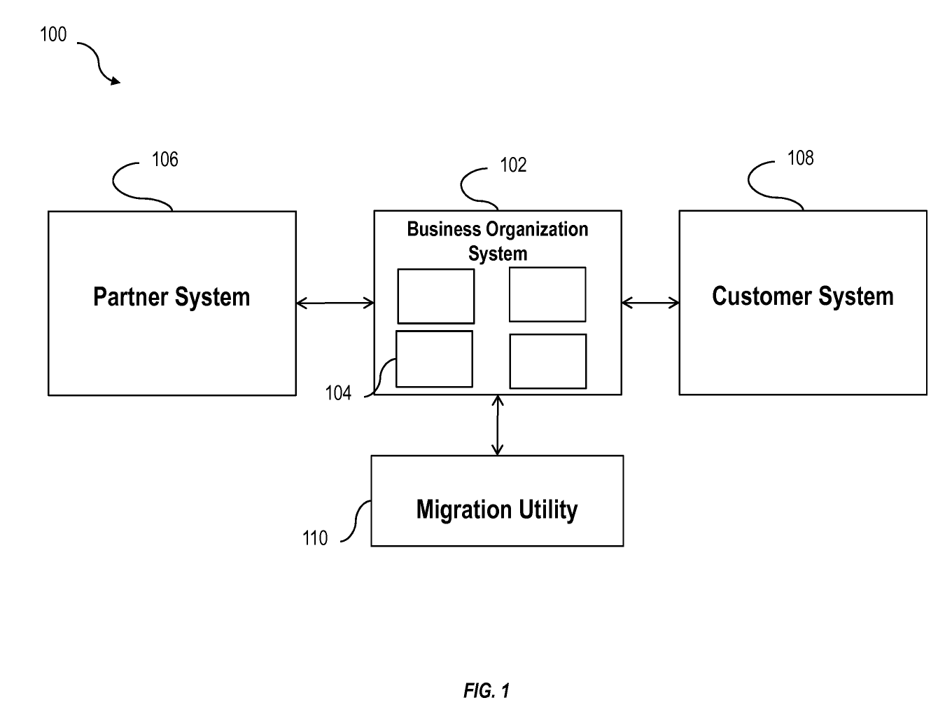

FIG. 1 illustrates an exemplary system 100 that can include a file system 102 containing a plurality of various business process applications 104 which a business organization may offer to its customers 108 (either free or for purchase). The business process applications can be generated by the business organization offering these applications and/or by various partners 106 of the business organization that can create applications and provide these to the business organization to offer to its customers through the file system 102. Thus, the file system 102 can be a marketplace that a business customer 108 can access and obtain desired business process applications. In some implementations, the business customer 108 can also provide the business organization with various customer requirements for business process applications, which the business organization and/or its partners can accommodate by creating and providing to the customer business process applications in accordance with provided customer specifications.

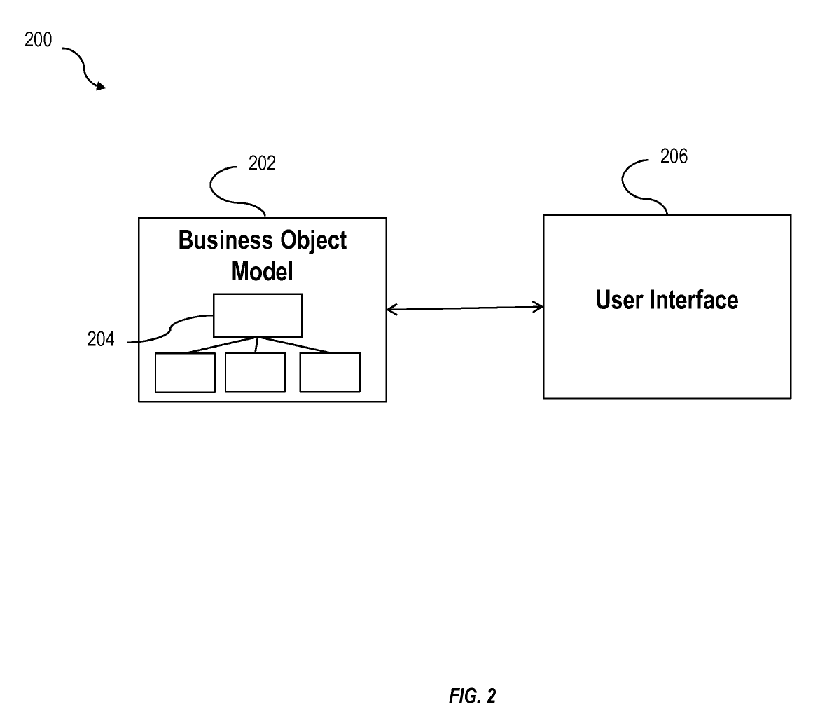

As shown in FIG. 2, a business organization system 200 can include a core business object model 202 that can include a plurality of business objects 204, which can have a root node and/or child nodes that can correspond to various aspects in the business objects. For example, in a sales order object, a root node can be a sales order header and child nodes can be various items in the order. A user can view, manipulate, update, etc. the business object using a user interface 206 that can include at least one anchor. An anchor in the user interface can correspond to a particular feature displayed in the user interface, which in turn can correspond to a node in the business object. An anchor in the user interface can be a location where an extension field corresponding to an add-on or other business object, business process, and/or data flow can be added. In some implementations, the business process organization core object model (e.g., a sales model business object, an accounting model business object, etc.) can be used by various types of metadata objects such as data types, business objects, inbound and outbound process agents, inbound service interfaces, process component interaction, multi-dimensional analytical views, as well as any other objects, which can correspond to various fields in the business object. Business objects, add-ons, etc. can interact with the business object mode through the anchor placed in the user interface. An update and/or change to the anchor and/or core business object model can affect existence and usability of the anchor (e.g., the anchor can be deleted, changed, etc.) in a way that other business objects, add-ons, etc. will not be able to interact with the core business object model anymore. The current subject matter system can determine when there is a need to update the information (e.g., metadata and/or other data associated with the extension field corresponding to the anchor) and provide that update to the partners and/or customers so as to enable such partners and/or customers to continue interacting with the core business object model as well as continue using other business objects, add-ons, etc. that work with the core business object model.

Business organizations and/or its partners can change, update, and/or extend features of various offered business process applications and provide those features to the customers. As stated above, such offerings can be accomplished through field extensibility and can enable customers and/or partners to add various extension fields to already existing business processes, business objects and/or data flows that are may be part of various products offered through the marketplace 102, as shown in FIG. 1. Periodically, the business organization can update its core product, such as by offering a new version of the existing core product and/or replacing the old core product with the new core product, where the updated and/or new core product can be designed to work with existing business process applications and/or add-ons that may have been created by the business organization and/or its partners and/or are being used by the customers. To ensure continuous operation and use of the business process applications and/or add-ons by the customers and/or partners of the business organization subsequent to the update and/or change of the core product, the current subject matter system can update and/or correct metadata associated with field extensions of various business process applications and/or add-ons that worked with the core product so that such business process applications and/or add-ons can now work with the updated and/or changed core product. The current subject matter can also perform an execution of program after import (“XPRA”) check to determine whether the business process applications and/or add-ons can function with the updated and/or changed core products. The XPRA check can also be ran at any time to ascertain whether the business process applications and/or add-ons can function with the current version of the core product. The metadata update and/or correction can occur at partner and/or customer sites, but might not occur at the file system.

In some implementations, the current subject matter system can include a migration utility application 110 (shown in FIG. 1) that, upon update/change of the core product, can determine changes and/or updates to existing business objects, extensions, etc. and can provide such updates to partners and/or customers to ensure continuous operation. The migration utility can migrate all cross business object associations on the current projection business objects to new projection business objects. If an application supports more than one product type then the application can model more than one cross business object association for each product type. The migration utility can update the metadata tables that can contain data and metadata associated with the business objects, business processes, data flows, add-ons, field extensions, etc. as well as check consistency of the data and metadata being updated.

In some implementations, the migration utility can migrate existing extensibility metadata and/or other data associated with the existing core business object model to the new business object model. The new business object model can represent an update, a change, replacement, etc. of the existing core business object model. The metadata and/or other data that can be associated with the field extensions of various business objects, add-ons, etc. that can be provided by partners and/or used by customers of the business organization, can be stored in various metadata extensibility tables. Such tables can be stored in a database and/or any other storage facility that can be accessed by business processes as necessary. When metadata and/or other data is migrated as a result of the change from the old business object model to the new one, partners and/or customers of the business organization can undergo a similar migration by adopting new business object model as well.

During migration from the existing business object model to the new business object model, the migration utility can retain node identification information with which the extension fields are associated as well as reference field names that are associated with existing business object model, where the reference field names can point to new business objects as a result of change from the old business object model to the new one. The migration process can involve migration of the data and migration of metadata associated with field extensibility from the existing business object model to the new business object model.

The extensibility data can be migrated according to the following process. The extensibility data stored in the extensibility tables associated with the existing business object model can be copied to product data management (“PDM”) product extensibility tables and a mapping can be established between PDM business objects and product extensibility tables associated with the new business object model. The using the XPRA check process, the extensibility data can be migrated from the extensibility tables associated with the existing business object model to the extensibility tables associated with the new business object model. The XPRA check process can ensure consistency of data during the migration process.

During data migration of the core persistency application programming interfaces from field extensibility can be called to read field extension data from for the existing business object model and write field extension data for the new business object model. This migration process can ensure that customer and/or partner field content is properly migrated from the existing business object model to the new business object model. In some implementations, since the node identification information does not change when the old business object model is changed to the new business object model, it can be used to migrate extensibility data from the existing business object model to the new one.

Metadata migration can be accomplished by migrating all custom fields of the existing business object model as stored in the metadata repository system (“MDRS”) to the new business object model and using product extensibility XPRA check process to update and/or modify such MDRS custom fields. Further, each time a field extensibility generation takes place the exchange patterns mentioned above can be applied to a custom field. These exchange patterns can be carried out every time field extensibility generation is triggered, e.g., during upgrades of business object models, addition of partner add-ons, etc.

In some implementations, all extensibility metadata from the existing business object model can be migrated to the new business object model and associated business objects, which can account for situation when it is not known what extension field can be used with what product/service type. To perform such migration, a check can be performed to determine whether there exist any instances of business objects, add-ons, etc. corresponding to products/services in the existing business object model. If it is determined that some products/services have not been scoped, then extensibility metadata and data creation information for only those products/services can be migrated to the new business object model. Otherwise, all extensibility field metadata can be migrated to the new business object model.

After change/upgrade from the existing business model to the new business model and migration of extensibility data and metadata, all new extension data and extension metadata can be supported in the new business object model. Further, the customers and/or partners may be prevented from accessing existing (now old) business object model and its extensibility data and metadata once the migration occurs. New user interface(s) that can be created as a result of update/change to new business object model can fetch data for new extension fields as well as retrieve information from old business object nodes by making appropriate calls to the new business object model.

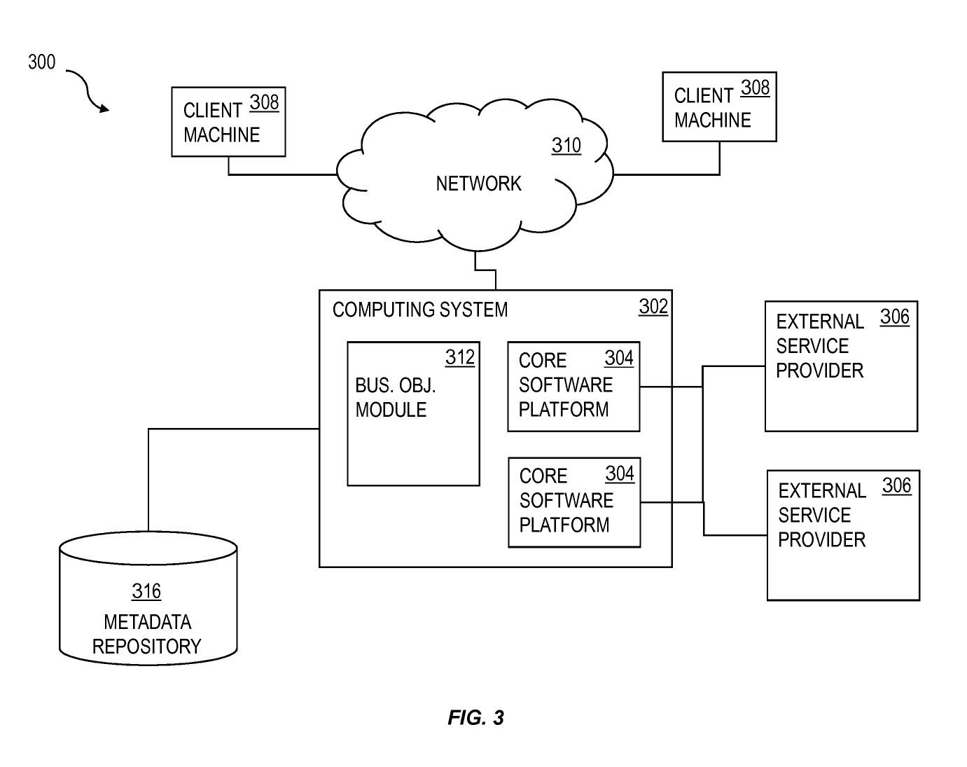

The above migration process can be implemented using a business organization's core software platform such as the one of an enterprise resource planning (ERP) system, other business software architecture, or other database functionality and can in some implementations be provided as a standalone, customized software installation that runs on one or more processors that are under the control of the organization. This arrangement can be very effective for a large-scale organization that has very sophisticated in-house information technology (IT) staff and for whom a sizable capital investment in computing hardware and consulting services required to customize a commercially available business software solution to work with organization-specific business processes and functions is feasible. FIG. 3 shows a diagram of a system consistent with such an implementation. A computing system 302 can include one or more core software platform modules 304 providing one or more features of the business software system. In some implementations, the computing system 302 can be an application server. The computing system 302 can also aggregate or otherwise provide a gateway via which users can access functionality provided by one or more external service providers 306. Examples of external service providers 306 can include one or more computing systems supporting database functionality or other software functionality created or provided from a partner or other third party software developer. This external service provider database functionality or other software functionality can be provided over either direct or networked connections if the one or more external provider computing systems are separate from the computing system 302 that includes one or more core software platform modules 304. Alternatively, the external service provider database functionality or other software functionality can be hosted on the computing system 302 that includes the one or more core software platform modules 304.

Client machines 308 can access the computing system, either via a direct connection, a local terminal, or over a network 310 (e.g. a local area network, a wide area network, a wireless network, the Internet, or the like). A business object module 312 or multiple such modules can execute on the computing system 302, on one or more separate systems, or any combination thereof to perform one or more of the business object management operations. One or more features of the methods, techniques, approaches, etc. relating to functionality of a single extension field naming module 312 can be performed by multiple modules, which can be implemented within a single system that includes one or more processors or on multiple systems that each include one or more processors. The business object module 312 can access one or more metadata repositories 316 (referred to generally herein in the singular as a metadata repository 316), which can retain one or more of metadata for use by at least one of the one or more core software platform modules 304 and the database functionality or other software functionality provided by one or more external service providers 306. The metadata repository 316 can also retain metadata relating to the core business object model in a first (e.g. a foundation) layer of the layer business software architecture and metadata relating to the cross-layer extensions to the core business object model. The metadata repository 316 can also store objects or other elements, such as for example business objects, metadata objects, or the like. These objects or other elements can include definitions of business scenarios, business processes, and one or more business configurations as well as data, metadata, master data, etc. relating to definitions of the business scenarios, business processes, and one or more business configurations, and/or concrete instances of the data objects (e.g., business objects) that are relevant to a specific instance of the business scenario or a business process. In some implementations, a business object or other metadata object can include a template definition of a standard business process or other related functionality. The template definition can optionally be modified via one or more extensions that can also be stored in the one or more repositories 316. The one or more repositories can also include storage for data relating to the business or other aspects of the organization.

Smaller organizations can also benefit from use of business software functionality. However, such an organization may lack the necessary hardware resources, IT support, and/or consulting budget necessary to make use of a standalone business software architecture product and can in some cases be more effectively served by a software as a service (“SaaS”) arrangement in which the business software system architecture is hosted on computing hardware such as servers and data repositories that are maintained remotely from the organization's location and accessed by authorized users at the organization via a thin client, such as for example a web browser, over a network.

In a software delivery configuration in which services of an business software system are provided to each of multiple organizations are hosted on a dedicated system that is accessible only to that organization, the software installation at the dedicated system can be customized and configured in a manner similar to the above-described example of a standalone, customized software installation running locally on the organization's hardware. However, to make more efficient use of computing resources of the SaaS provider and to provide important performance redundancies and better reliability, it can be advantageous to host multiple tenants on a single system that includes multiple servers and that maintains data for all of the multiple tenants in a secure manner while also providing customized solutions that are tailored to each tenant's business processes.

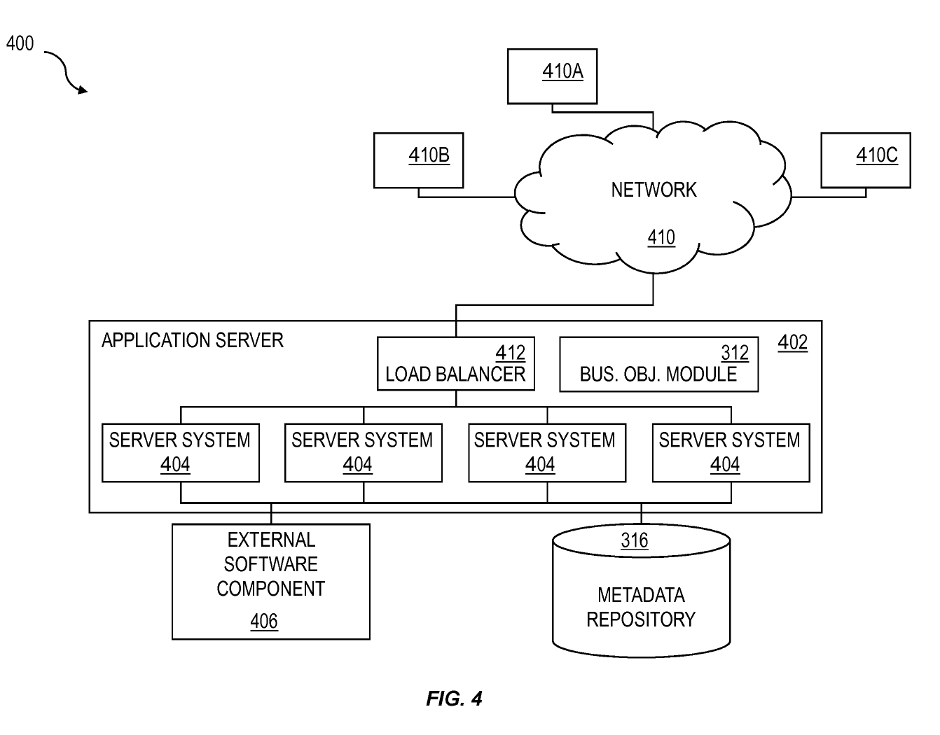

FIG. 4 shows a block diagram of a multi-tenant implementation of a software delivery architecture 400 that includes an application server 402, which can in some implementations include multiple server systems 404 that are accessible over a network 406 from client machines operated by users at each of multiple organizations 410A-410C (referred to herein as “tenants” of a multi-tenant system) supported by a single software delivery architecture 400. For a system in which the application server 402 includes multiple server systems 404, the application server can include a load balancer 412 to distribute requests and actions from users at the one or more organizations 410A-410C to the one or more server systems 404. Instances of the core software platform 304 (not shown in FIG. 4) can be executed in a distributed manner across the server systems 404. A user can access the software delivery architecture across the network using a thin client, such as for example a web browser or the like, or other portal software running on a client machine. The application server 402 can access data and data objects stored in one or more metadata repositories 316 which can make one or more of metadata and other data available for use by at least one of the one or more core software platform modules 304 and the database functionality or other software functionality provided by one or more external service providers 306. The application server 402 can also serve as a middleware component via which access is provided to one or more external software components 306 that can be provided by third party developers.

As in the standalone system 300 of FIG. 3, business object module 312 or multiple such modules can execute on the computing system 302, on one or more separate systems, or any combination thereof to perform as discussed elsewhere herein. The business object module 312 can access a metadata repository 316, which, as noted above, can be part of or directly accessible to the application server 402, or, alternatively or in addition, can be located remotely or optionally spread over one or more physical or virtual servers, for example as in a cloud computing arrangement. The business object module or modules 312 can execute on the application server 402, on one or more separate application servers, or any combination thereof to perform one or more of the operations discussed in greater detail above. The metadata repository 316 can store metadata similar to that discussed above in reference to FIG. 3.

A multi-tenant system such as that described herein can include one or more of support for multiple versions of the core software and backwards compatibility with older versions, stateless operation in which no user data or business data are retained at the thin client, and no need for tenant configuration on the central system. As noted above, in some implementations, support for multiple tenants can be provided using an application server 402 that includes multiple server systems 404 that handle processing loads distributed by a load balancer 412. Potential benefits from such an arrangement can include, but are not limited to, high and reliably continuous application server availability and minimization of unplanned downtime, phased updating of the multiple server systems 404 to permit continuous availability (one server system 404 can be taken offline while the other systems continue to provide services via the load balancer 412), scalability via addition or removal of a server system 404 that is accessed via the load balancer 412, and de-coupled life cycle events or processes (such as for example system maintenance, software upgrades, etc.) that enable updating of the core software independently of tenant-specific customizations implemented by individual tenants.

As in the example illustrated in FIG. 3, the repository 316 can store a business object that represents a template definition of a standard business process. Each individual tenant 410A-410C can customize that standard template according to the individual business process features specific to business of the organization to which that tenant is assigned. Customizations can be stored as extensions in the metadata repository.

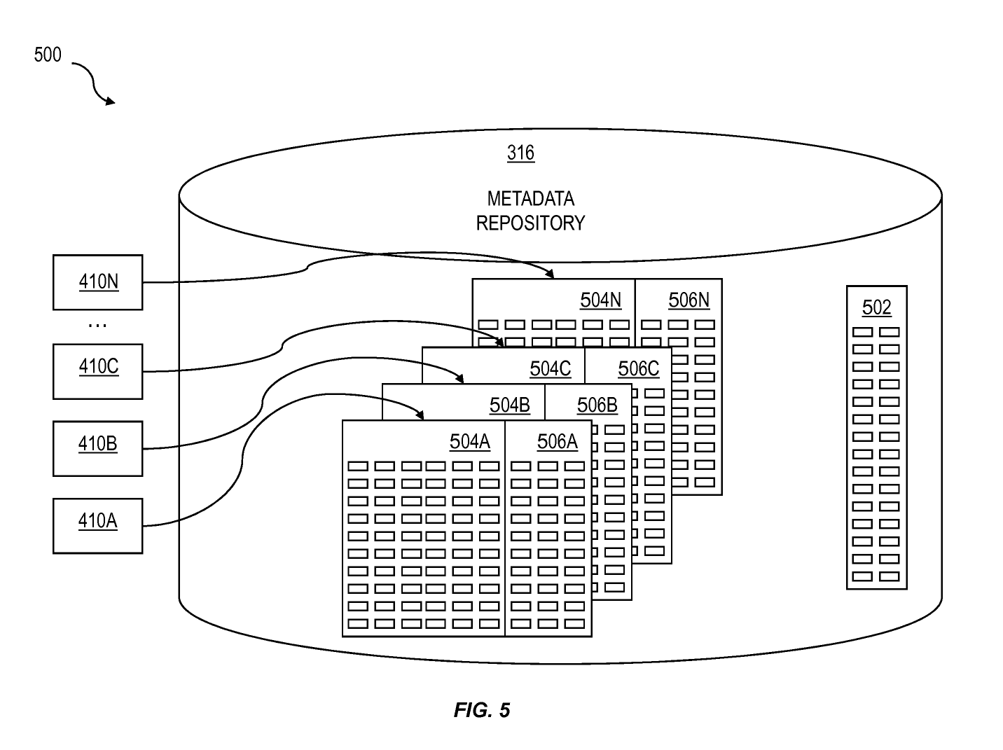

To provide for customization of the business process for each of multiple organizations supported by a single software delivery architecture 400, the data and data objects stored in the metadata repository 316 and/or other data repositories that are accessed by the application server 402 can include three types of content as shown in FIG. 5: core software platform content 502 (e.g. a standard definition of a business process), system content 504, and tenant content 506. Core software platform content 502 includes content that represents core functionality and is not modifiable by a tenant. System content 504 can in some examples be created by the runtime of the core software platform and can include core data objects that store concrete data associated with specific instances of a given business process and that are modifiable with data provided by each tenant. Metadata relating to one or more of core software platform content 502, system content 504, and content provided by the one or more external service providers 306 can optionally be part of a system tenant that is accessible from all other tenants 410A-410N.

The data and/or the metadata retained in the tenant content 506 can be tenant-specific: for example, each tenant 410A-410N can store information about its own inventory, sales orders, etc. as well as metadata pertaining to extensions, processes, or the like that are specific to the organization assigned to that tenant. Tenant content 506A-506N can therefore include data objects or extensions to other data objects that are customized for one specific tenant 410A-410N to reflect business processes and data that are specific to that specific tenant and are accessible only to authorized users at the corresponding tenant. Such data objects can include a key field (for example “client” in the case of inventory tracking) as well as one or more of master data, business configuration information, transaction data or the like. For example, tenant content 506 can reflect tenant-specific modifications or changes to a standard template definition of a business process as well as tenant-specific customizations of the business objects that relate to individual process step (e.g. records in generated condition tables, access sequences, price calculation results, other tenant-specific values, or the like). A combination of the software platform content 502 and system content 504 and tenant content 506 of a specific tenant are accessed to provide the business process definition and/or the status information relating to a specific instance of the business process according to customizations and business data of that tenant such that each tenant is provided access to a customized solution whose data are available only to users from that tenant.

One or more life cycle events or processes of an application server 302 can cause invalidation of the metadata retained in a buffer. A life cycle event in this context can refer to one or more of an import, an upgrade, a hot fix, or the like of one or more business objects or other data objects into a core software platform module 304 of a business software architecture or the database functionality or other software functionality provided by one or more external service providers 306. In the example of a multi-tenant approach such as described above in reference to FIG. 4 and FIG. 5, life cycle events affecting features of one or more core software platform modules 304 or of database functionality or other software functionality provided by one or more external service providers 306 can be performed in the system tenant. Similarly, other life cycle events that affect multiple tenants (e.g. scalable add-ons that can be active in multiple tenants) can also be performed on the system tenant. Life cycle events that affect only one tenant, for example upgrading, importing, hot fixing, etc. of an add-on or other custom feature that is used by only a single customer of the business software architecture; switching on or off a scalable add-on functionality for a single tenant; creating or modifying an extension to core software platform content 502, system content 504, or database functionality or other software functionality provided by one or more external service providers 306; or the like can be implemented only in the affected tenant.

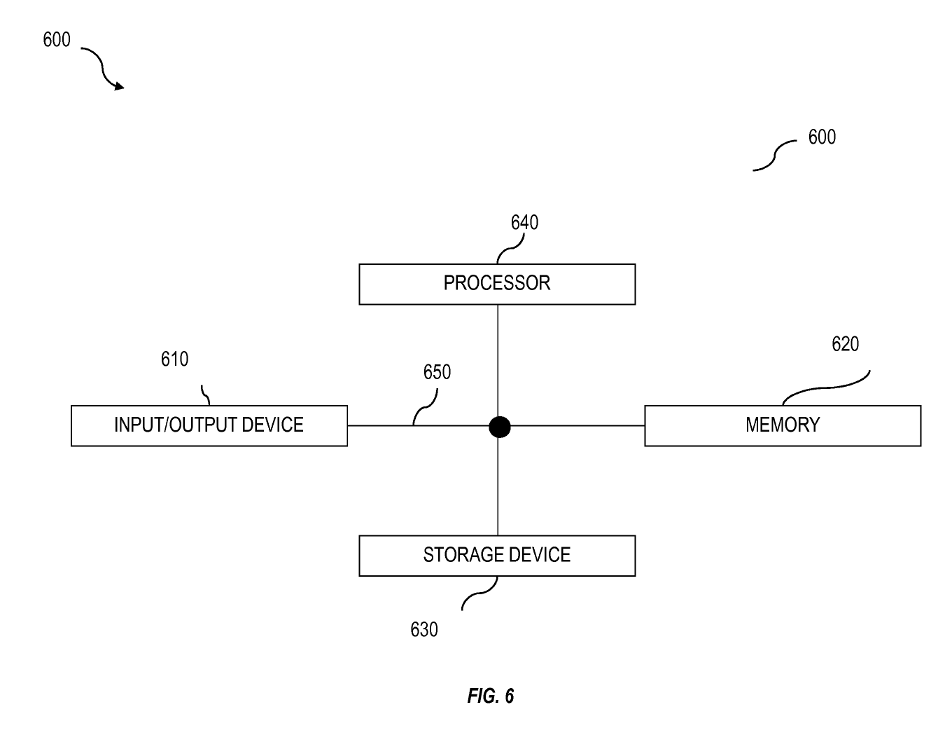

In some implementations, the current subject matter can be configured to be implemented in a system 600, as shown in FIG. 6. The system 600 can include a processor 610, a memory 620, a storage device 630, and an input/output device 640. Each of the components 610, 620, 630 and 640 can be interconnected using a system bus 650. The processor 610 can be configured to process instructions for execution within the system 600. In some implementations, the processor 610 can be a single-threaded processor. In alternate implementations, the processor 610 can be a multi-threaded processor. The processor 610 can be further configured to process instructions stored in the memory 620 or on the storage device 630, including receiving or sending information through the input/output device 640. The memory 620 can store information within the system 600. In some implementations, the memory 620 can be a computer-readable medium. In alternate implementations, the memory 620 can be a volatile memory unit. In yet some implementations, the memory 620 can be a non-volatile memory unit. The storage device 630 can be capable of providing mass storage for the system 600. In some implementations, the storage device 630 can be a computer-readable medium. In alternate implementations, the storage device 630 can be a floppy disk device, a hard disk device, an optical disk device, a tape device, non-volatile solid state memory, or any other type of storage device. The input/output device 640 can be configured to provide input/output operations for the system 600. In some implementations, the input/output device 640 can include a keyboard and/or pointing device. In alternate implementations, the input/output device 640 can include a display unit for displaying graphical user interfaces.

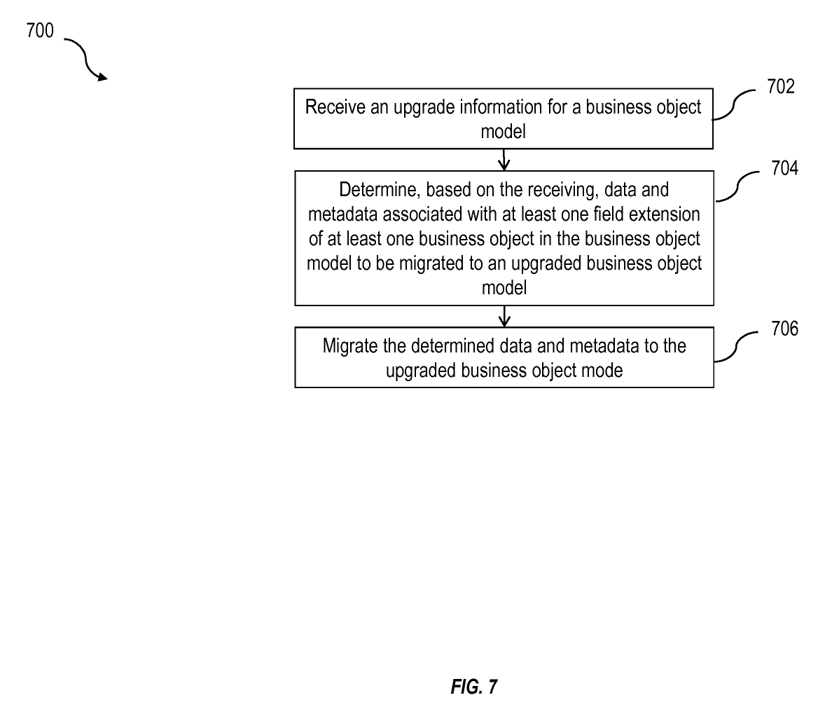

FIG. 7 illustrates an exemplary method, according to some implementations of the current subject matter. At 702, upgrade information for a business object model can be received. At 704, data and metadata associated with at least one field extension of at least one business object in the business object model to be migrated to an upgraded business object model can be determined based on the received upgrade information. At 706, the determined data and metadata can be migrated to the upgraded business object model. At least one of the receiving, the determining, and the migrating can be performed on at least one processor.

In some implementations, the current subject matter can include at least one or more of the following optional features. The method can include at least the following: performing a consistency check of the determined data associated with the at least one field extension of the at least one business object, determining whether the data passed the consistency check, and storing the determined data in the upgraded business object model.

The method can also include performing a consistency check of the determined metadata associated with the at least one field extension of the at least one business object, determining whether the metadata passed the consistency check, and storing the determined metadata in the upgraded business object model.

In some implementations, the data and metadata can be stored in at least one extensibility table. At least one extensibility table can be migrated to the upgraded business object model. The method can also include performing a consistency check of the at least one extensibility table.

The method can further include determining existence of at least one custom field extension in the business object model, migrating the at least one custom field extension from to the upgraded business object model, and performing a consistency check of the migrated at least one custom field extension.

In some implementations, at least one field extension represents at least one business process associated with the business object model.

In some implementations, the method can also include performing a consistency check of the at least one field extension of the at least one business object during at least one: a deployment of the at least one business object in the at least one of the business object model and the upgraded business object model, and a regeneration of the at least one business object in the at least one of the business object model and the upgraded business object model.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer-implemented method, comprising:
receiving an upgrade information for a business object model;
determining, based on the receiving, data and metadata associated with at least one field extension of at least one business object in the business object model to be migrated to an upgraded business object model; and
migrating the determined data and metadata to the upgraded business object model;
wherein the at least one of the receiving, the determining, and the migrating is performed on at least one processor.

2. The method according to claim 1, further comprising
performing a consistency check of the determined data associated with the at least one field extension of the at least one business object;
determining whether the data passed the consistency check; and
storing the determined data in the upgraded business object model.

3. The method according to claim 1, further comprising
performing a consistency check of the determined metadata associated with the at least one field extension of the at least one business object;
determining whether the metadata passed the consistency check; and
storing the determined metadata in the upgraded business object model.

4. The method according to claim 1, wherein the data and metadata are stored in at least one extensibility table;
wherein the at least one extensibility table is migrated to the upgraded business object model.

5. The method according to claim 4, further comprising
performing a consistency check of the at least one extensibility table.

6. The method according to claim 1, further comprising
determining existence of at least one custom field extension in the business object model;
migrating the at least one custom field extension from to the upgraded business object model; and
performing a consistency check of the migrated at least one custom field extension.

7. The method according to claim 1, wherein the at least one field extension represents at least one business process associated with the business object model.

8. The method according to claim 1, further comprising
performing a consistency check of the at least one field extension of the at least one business object during at least one: a deployment of the at least one business object in the at least one of the business object model and the upgraded business object model, and a regeneration of the at least one business object in the at least one of the business object model and the upgraded business object model.

9. A computer program product comprising a machine-readable medium storing instructions that, when executed by at least one programmable processor, cause the at least one programmable processor to perform operations comprising:
receiving an upgrade information for a business object model;
determining, based on the receiving, data and metadata associated with at least one field extension of at least one business object in the business object model to be migrated to an upgraded business object model; and
migrating the determined data and metadata to the upgraded business object model.

10. The computer program product according to claim 9, wherein the operations further comprise
performing a consistency check of the determined data associated with the at least one field extension of the at least one business object;
determining whether the data passed the consistency check; and
storing the determined data in the upgraded business object model.

11. The computer program product according to claim 9, wherein the operations further comprise
performing a consistency check of the determined metadata associated with the at least one field extension of the at least one business object;
determining whether the metadata passed the consistency check; and
storing the determined metadata in the upgraded business object model.

12. The computer program product according to claim 9, wherein the data and metadata are stored in at least one extensibility table;
wherein the at least one extensibility table is migrated to the upgraded business object model.

13. The computer program product according to claim 12, wherein the operations further comprise
performing a consistency check of the at least one extensibility table.

14. The computer program product according to claim 9, wherein the operations further comprise
determining existence of at least one custom field extension in the business object model;
migrating the at least one custom field extension from to the upgraded business object model; and
performing a consistency check of the migrated at least one custom field extension.

15. The computer program product according to claim 9, wherein the at least one field extension represents at least one business process associated with the business object model.

16. The computer program product according to claim 9, wherein the operations further comprise
performing a consistency check of the at least one field extension of the at least one business object during at least one: a deployment of the at least one business object in the at least one of the business object model and the upgraded business object model, and a regeneration of the at least one business object in the at least one of the business object model and the upgraded business object model.

17. A system comprising:
at least one programmable processor; and
a machine-readable medium storing instructions that, when executed by the at least one programmable processor, cause the at least one programmable processor to perform operations comprising:
receiving an upgrade information for a business object model;
determining, based on the receiving, data and metadata associated with at least one field extension of at least one business object in the business object model to be migrated to an upgraded business object model; and
migrating the determined data and metadata to the upgraded business object model.

18. The system according to claim 17, wherein the operations further comprise
performing a consistency check of the determined data and/or metadata associated with the at least one field extension of the at least one business object;
determining whether the data and/or metadata passed the consistency check; and
storing the determined data and/or metadata in the upgraded business object model.

19. The system according to claim 17, wherein the data and metadata are stored in at least one extensibility table;
wherein the at least one extensibility table is migrated to the upgraded business object model;
wherein the operations further comprise performing a consistency check of the at least one extensibility table.

20. The system according to claim 17, wherein the operations further comprise
determining existence of at least one custom field extension in the business object model;
migrating the at least one custom field extension from to the upgraded business object model; and
performing a consistency check of the migrated at least one custom field extension.
